(19) United States
(12) Patent Application Publication
(10) Pub. No.: US 2026/0208431 A1
(43) Pub. Date: Jul. 23, 2026

(54) HIGH SPEED OFF-LINE EMBOSSING

(71) Applicant: Boegli-Gravures SA, Marin-Epagnier (CH)

(72) Inventors: Charles BOEGLI, Marin-Epagnier (CH); Gabriel DUMITRU, Neuchâtel (CH); Max HEGGLIN, Brügg (CH)

(21) Appl. No.: 19/137,764

(22) PCT Filed: Nov. 22, 2023
(86) PCT No.: PCT/IB2023/061803

§ 371 Date: Jun. 11, 2025

(30) Foreign Application Priority Data
Dec. 20, 2022 (EP) 22215159.9

(51) Int. Cl. B29C 59/04; B29C 43/30; B29C 43/46; B29C 59/02

(52) U.S. Cl. CPC B29C 59/046; B29C 43/305; B29C 43/46; B29C 59/022; B29C 2043/463; B29C 2059/023

(57) ABSTRACT

A method for seamlessly embossing micro- or nanostructures into at least one thermoformable layer of a sandwich structure, the sandwich structure comprising a layer of carrier substrate and a cover made of the at least one thermoformable layer. The micro- or nanostructures comprise at least embossing structures that are a combination of a plurality of structures, the combination comprising a first structure and a second structure, with respectively a first width and a second width in a scale of at least 5 to 1, or respectively a first height and a second height in the scale of at least 5 to 1. The method further comprises melting material of the at least one thermoformable layer to a viscous phase; applying the molten material of the at least one thermoformable layer onto the layer of carrier substrate to obtain the sandwich structure prior to embossing; maintaining the material of the at least one thermoformable layer in the viscous phase prior to embossing; feeding the sandwich structure in a nip of a set of a first embossing roller and a second embossing roller, the first embossing roller and the embossing micro- or nanostructures carried thereon being made from a single bulk material, the first embossing roller comprising the embossing micro- or nanostructures in form of at least a protrusion and/or at least a recess on its cylindrical surface, the second embossing roller having a smooth cylindrical surface, the at least one thermoformable layer of material being oriented towards the first embossing roller and the layer of carrier substrate oriented towards the second embossing roller; embossing the micro- or nanostructures into the at least one thermoformable layer; and controlling a temperature of the sandwich structure at an output of the nip to a solidifying temperature of the at least one thermoformable layer.

### TECHNICAL FIELD

The invention is in the field of off-line embossing of micro- or nanostructures in a sandwich structure comprising a carrier substrate and a cover made of a thermoformable layer of material in a viscous phase.

### BACKGROUND ART

It is generally known to emboss structures in a sandwich structure comprising a ground substrate and a viscous layer of material. U.S. Pat. No. 10,532,510 B2 to Pranov et al. relates to a method for manufacturing foils with a thermoplastic surface comprising what is claimed to be high-aspect ratio micro- or nanostructures. It explains that the term “high-aspect ratio structure” means a structure in which the width of the structure is low, and the depth of the structure is high. It further explains that the molding of such structures is challenging due to the rapid cooling of the melt surface. In the solution presented, the micro or nanostructured thermoplastics coating is produced by micro- or nanostructuring a cooling roller and by carefully choosing the extrusion coating process parameters. The throughput rate of the sandwich structure achieved may be in a range of 5-10 m²/s. The process is able to make continuous areas of micro or nanostructures without significant seam lines and the ability to cover the whole area of the manufactured foil. Coming back to the aspect ratio of the micro or nanostructures, the publication states that this is above 2, more preferably above 1.5 and most preferably more than 1. The seam lines between individual high aspect ratio nanostructured areas have a width most preferably less than 2 μm, hence there are seam lines in this range of measurement. The cooling roller may be made by the application of a thin layer of liquid ceramic material precursor solution, then structuring the so-formed film by a mechanical process such as embossing, and curing it to a film of structured solid ceramic material and using it for the purpose of embossing the micro or nanostructures. Hence the U.S. Pat. No. 10,532,510 B2 has an inherent strong limitation in the height to depth ratio (the aspect ratio) of the embossed micro or nanostructures that are possible to emboss.

The present invention aims at improving the prior art method for embossing micro or nanostructures in a sandwich structure comprising the ground substrate and the thermoformable layer in a viscous phase, to obtain micro or nanostructures with proportions and more particularly heights not achievable in prior art.

Further aims of the present invention may include to eliminate seam lines between high aspect ratio nanostructured areas, achieve higher throughput rates of the sandwich structure, and emboss nano or microstructures which are made individually from a combination of structures respectively dimensioned with a plurality of scales from one to another.

### SUMMARY OF INVENTION

In a first aspect, the invention provides a method for seamlessly embossing micro- or nanostructures into at least one thermoformable layer of a sandwich structure, the sandwich structure comprising a layer of carrier substrate and a cover made of the at least one thermoformable layer. The micro- or nanostructures comprise at least embossing structures that are a combination of a plurality of structures, the combination comprising a first structure and a second structure, with respectively a first width and a second width in a scale of at least 5 to 1, or respectively a first height and a second height in the scale of at least 5 to 1. The method further comprises melting material of the at least one thermoformable layer to a viscous phase; applying the molten material of the at least one thermoformable layer onto the layer of carrier substrate to obtain the sandwich structure prior to embossing; maintaining the material of the at least one thermoformable layer in the viscous phase prior to embossing; feeding the sandwich structure in a nip of a set of a first embossing roller and a second embossing roller, the first embossing roller and the embossing micro- or nanostructures carried thereon being made from a single bulk material, the first embossing roller comprising the embossing micro- or nanostructures in form of at least a protrusion and/or at least a recess on its cylindrical surface, the second embossing roller having a smooth cylindrical surface, the at least one thermoformable layer of material being oriented towards the first embossing roller and the layer of carrier substrate oriented towards the second embossing roller; embossing the micro- or nanostructures into the at least one thermoformable layer; and controlling a temperature of the sandwich structure at an output of the nip to a solidifying temperature of the at least one thermoformable layer.

In a preferred embodiment, the feeding of the sandwich structure in the nip is done at a speed between 50 m/min and 1500 m/min.

In a further preferred embodiment, the feeding of the sandwich structure in the nip is done at a speed between 100 and 500 m/min.

In a further preferred embodiment, the carrier substrate is made of a fiber-based substance; and the step of applying of the molten material of the at least one thermoformable layer onto the layer of carrier substrate causes at least part of the molten material of the at least one thermoformable layer to infiltrate into interstices between the fibers the carrier substrate, thereby forming a strengthened conglomerate.

In a further preferred embodiment, the applying of the molten material of the at least one thermoformable layer onto the layer of carrier substrate comprises an injection under pressure of the molten material.

In a further preferred embodiment, the step of maintaining the material of the at least one thermoformable layer in a viscous phase comprises a thermal management of the material of the thermoformable layer by any one of the means from the list comprising an oven, an infrared source of heat, an electromagnetic radiation source, a heated mass, pressure heating.

In a further preferred embodiment, the first embossing roller comprises a single metal or a metallic alloy from the following list comprising steel, copper, aluminum, lead, nickel, tin, titanium, zinc, brass and bronze.

In a further preferred embodiment, the first embossing roller comprises a ceramic material such as carbides, oxides, nitrides, carbo-nitrides of one of the following elements: B, Al, Si, Cr, Ti or any combination thereof.

In a further preferred embodiment, the micro- or nanostructures further comprise any one of grooves and ridges.

In a further preferred embodiment, the thermoformable material is any one of the list comprising a thermoformable polymer and a thermoformable elastomer.

In a further preferred embodiment, the method further comprises providing the embossing roller with a coating configured to prevent an adhesion of the viscous phase of the at least one thermoformable layer, and to prevent a sticking phenomenon.

In a further preferred embodiment, the coating is a vacuum-deposited coating having a thickness of less than 10 μm, preferably less than 5 μm, and comprising diamond-like carbon (DLC) to homogeneously cover the micro or nanostructures.

In a further preferred embodiment, the carrier substrate material is any one of items from the list comprising a metallic film, a plastic film, a textile-based film, a foil, and a substrate with a fibrous structure.

In a further preferred embodiment, the method further comprises providing a second thermoformable layer on a side of the carrier substrate opposite to the side on which the at least one thermoformable layer is formed, maintaining a second material of the second thermoformable layer in a viscous phase prior to embossing; providing the second embossing roller with further micro- or nanostructures for embossing these in the second thermoformable layer; controlling a second temperature of the sandwich structure at an output of the nip to a solidifying temperature of the second thermoformable layer.

In a second aspect, the invention provides a system for seamlessly embossing micro- or nanostructures into at least one thermoformable layer of a sandwich structure, wherein the sandwich structure comprises a layer of carrier substrate and a cover made of the at least one thermoformable layer. The micro- or nanostructures comprise at least embossing structures that are a combination of a plurality of structures, the combination comprising a first structure and a second structure, with respectively a first width and a second width in a scale of at least 5 to 1, or respectively a first height and a second height in the scale of at least 5 to 1. The system comprises a melting system configured for melting material of the at least one thermoformable layer to a viscous phase; an application system configured for applying the molten material of the at least one thermoformable layer onto the layer of carrier substrate to obtain the sandwich structure prior to embossing; a first thermal management system configured for maintaining the material of the at least one thermoformable layer in the viscous phase prior to embossing; a conveyer system configured for feeding the sandwich structure in a nip of a set of a first embossing roller and a second embossing roller configured to emboss the micro or nanostructures into the at least one thermoformable layer. The first embossing roller and embossing micro- or nanostructures carried thereon are made from a single bulk material, the first embossing roller comprises the embossing micro- or nanostructures in form of at least a protrusion and/or at least a recess on its cylindrical surface. The second embossing roller has a smooth cylindrical surface, and the at least one thermoformable layer of material is oriented towards the first embossing roller and the layer of carrier substrate oriented towards the second embossing roller; and the system further comprises a second thermal management system configured for controlling a temperature of the sandwich structure at an output of the nip to a solidifying temperature of the at least one thermoformable layer.

In a further preferred embodiment, the sandwich structure further comprises a second thermoformable layer on a side of the carrier substrate opposite to the side on which the at least one thermoformable layer is formed, the first thermal management system is further configured to maintain a second material of the second thermoformable layer in the viscous phase prior to embossing; the second embossing roller is configured to comprise further micro- or nanostructures for embossing these in the second thermoformable layer; and the second thermal management system is further configured for controlling a second temperature of the sandwich structure at an output of the nip to a solidifying temperature of the second thermoformable layer.

### BRIEF DESCRIPTION OF THE DRAWINGS

The invention will be better understood through the detailed description of preferred embodiments and in reference to the following figures:

FIGS. 1A and 1B are schematic illustrations of set-ups for seamlessly embossing micro or nanostructures into at least one thermoformable layer of a sandwich structure according to example embodiments of the invention;

FIGS. 2A to 2D are schematic illustrations of embossing rollers comprising embossing micro or nanostructures according to example embodiments of the invention;

FIGS. 3A to 3E show layered materials embossed according to example embodiments of the invention;

FIG. 4 contains a flowchart illustrating an embossing of micro or nanostructures into a thermoformable layer of a sandwich structure according to an example embodiment of the invention;

FIGS. 5A to 5C contain schematic illustrations of set-ups to implement the method for seamlessly embossing according to example embodiments of the invention, wherein the applying of molten material of the thermoformable layer is realized in different manners;

FIGS. 6A to 6E contain photographs of surfaces of embossed thermoformable layer carrying micro or nanostructures embossed according to example embodiments of the invention;

FIGS. 7A to 7C illustrate examples of a thermoformable layer embossed with combined structures and conglomerates of these combined structures; and

FIG. 8 shows a preferred embodiment of an embossing roller according to the invention with a coating having anti-adhesion properties.

Same references will be used to designate same or similar features throughout the figures.

### DETAILED DESCRIPTION OF PREFERRED EMBODIMENTS

Glossary Width of structure: a length measure of a surface of a footprint of the structure on a base surface on which the structure is placed, along its smaller dimension. The base surface on which the structure is placed may, depending on the case, for example be the base surface of an embossing tool, typically the base surface of a cylindrical embossing tool, or the base surface of another structure on which the structure is placed. In case the footprint is a circle, then the surface of the footprint is a disc, and the width of the structure corresponds to a diameter of the circle or disc. In case the footprint is a rectangle, then the surface of the footprint is rectangularly shaped, and the width of the structure corresponds to the length of its smaller side. Of course, other footprints are possible.

Height of structure: the longest segment that can be placed inside the structure in a direction perpendicular from the base surface on which the structure is placed. In case the structure is a cube, the longest segment corresponds to a length of an edge that is perpendicular to the base surface on which the cube is placed. In case the structure is dome-shaped, the longest segment corresponds to a segment perpendicular to the base surface on which the dome is placed, connecting a point of the dome furthest away from the base surface. In case that dome is a half circular sphere, the longest segment corresponds to a radius of that sphere.

Scale: the term scale in the context of the present description designates a proportion between two sets of dimensions, typically a first set of dimensions belonging to a first structure and a second set of dimensions belonging to a second structure, whereby the first set of dimensions may consist of a first width of the first structure and the second set of dimensions may consist of a second width of the second structure. Hence the scale between the first structure and the second structure in this example would be the proportion of the first width and the second width.

Seamless embossing: engraving and embossing technology that enables a homogeneously jointed embossed structure(s) into a thermoformable layer of a sandwich structure. In other words, a homogeneity of the embossed structure(s) all over the embossed area is ensured and the parameters of pitch between embossing structure(s) and further dimensions thereof are preserved in the embossed versions of the embossing structures, i.e., all over a sheet of thermoformable layer of the sandwich structure.

Smooth: in the context of the present description, the term applies to the surface of a second embossing roller that is said to have a smooth cylindrical surface. This means that the surface has a Ra value smaller than 1.0 μm.

Embossing: in the context of the present description, the process of transferring the protrusions and/or the recesses of a surface topography of a bulk body into a viscous layer, whereas the viscous layer fills the recesses of the surface topography and upon solidifying (e.g., by cooling) adopts the mirrored surface topography of the bulk body. Under these conditions, the thickness of the viscous layer is preferably larger than the peak-to valley height between the highest protrusion and the lowest recess of the surface topography.

Off-line embossing: a situation in which the embossing process is entirely separate (i.e., different production lines or facilities, different premises) from the manufacturing process in which the embossed sandwich structure are utilized (e.g., final packaging), so that there is no communication between the embossing equipment and the packaging equipment. Bulk: in the context of the present description, the term “bulk” designates a tool which is made of a single material, i.e., an embossing tool which is made for example only of steel, or steel alloy, each being considered to be a “single material”.

### PREFERRED EMBODIMENTS

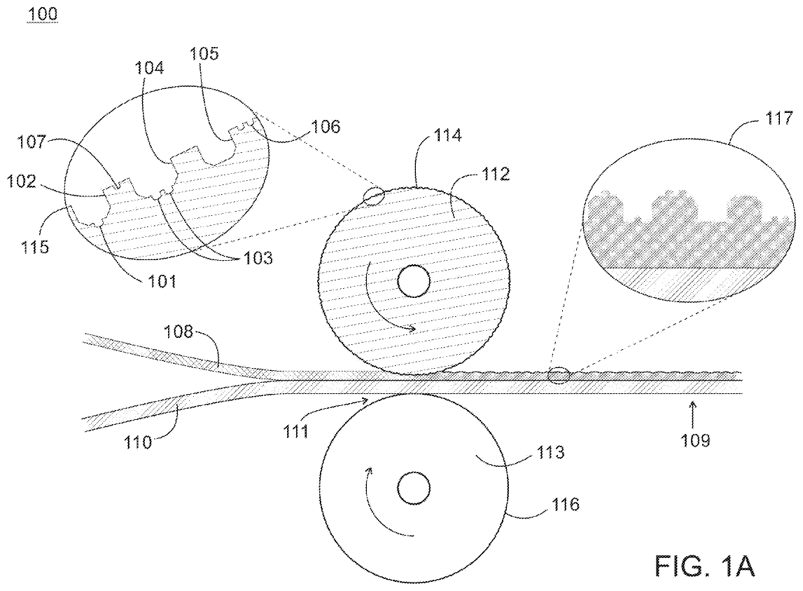

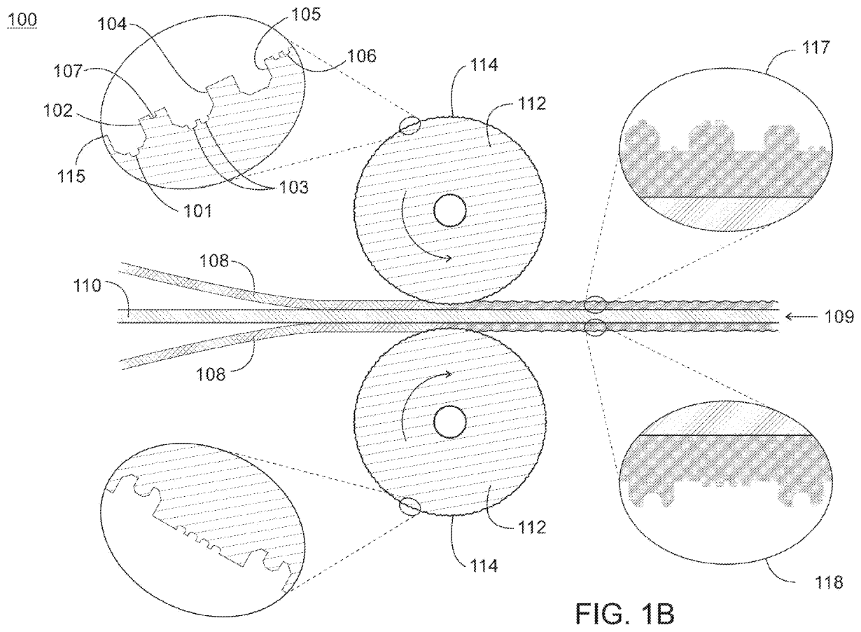

Referring to FIG. 1A, this contains a schematic illustration of a set-up 100 for seamlessly embossing micro- or nanostructures 101-107 (represented in a magnified view 115 of a cylindrical surface 114 of a first embossing roller 112) into a thermoformable layer 108 of a sandwich structure 109 according to an example embodiment of the invention. The sandwich structure 109 comprises a layer of a carrier substrate 110 and a cover made of the thermoformable layer 108. The micro- or nanostructures 101-107 comprise at least embossing structures that are a combination of a plurality of structures, the combination comprising a first structure 102, 104, and a second structure 101, 103 with respectively a first width and a second width (width not explicitly marked in FIG. 1A) in a scale of at least 5 to 1, meaning that the first width is at least 5 times greater than the second width. The structures in FIG. 1A are not necessarily represented in the correct scale. Alternatively, or at the same time, the first structure 102, 104, and the second structure 101, 103 respectively have a first height and a second height in the scale of at least 5 to 1, meaning that the first height is at least 5 times greater than the second height. This will be discussed in more detail based on further embodiments illustrated herein below. Before being applied onto the carrier substrate 110, the thermoformable layer 108 is melted to a viscous phase. This happens on the left-hand side of FIG. 1A where the carrier substrate 110 and the thermoformable layer 108 are disjoined, however no energy-delivering device used for melting the thermoformable layer 108 is illustrated for a better readability of the figure.

While it cannot be seen in FIG. 1A, the thermoformable layer 108 is maintained in a viscous phase prior to embossing, i.e., prior to being fed into a nip 111 formed between the first embossing roller 112 and the second embossing roller 113, which each turn around their respective axis according to rotation arrows represented in the rollers. The thermoformable layer 108 is fed in the nip 111 as part of the sandwich structure 109. The first embossing roller 112 carries the micro- or nanostructures 101-107 to be embossed, and the whole of the first embossing roller 112 including the micro- or nanostructures 101-107 are made from a single bulk material. The micro- or nanostructures 101-107 may be in form of at least a protrusion and/or at least a recess on the cylindrical surface 114 of the first embossing roller 112, whereby the examples illustrated in the magnified view 115 are in form of recesses only. The second embossing roller 113 has a smooth cylindrical surface 116.

The thermoformable layer 108 is oriented towards the first embossing roller 112 and the layer of carrier substrate 110 is oriented towards the second embossing roller 113. In the set-up 100 the micro- or nanostructures 101-107 are embossed into the thermoformable layer 108, a magnified view 117 showing embossed structures corresponding to embossing micro- or nanostructures 101-107. While the set-up 100 is represented schematically for a better readability, further aspects of the invention are not represented in FIG. 1A but will be described in further figures below since they need to be included in the inventive method and/or corresponding inventive system. These further aspects include a step of or corresponding means configured for controlling a temperature of the sandwich structure 109 at an output of the nip 111 to a solidifying temperature of the thermoformable layer 108.

The step of maintaining the material of the thermoformable layer 108 above a glass transition temperature of the material, so that it remains in the viscous phase prior to embossing, may for example be realized using any one of the means from the list comprising an oven, an infrared source of heat, an electromagnetic radiation source, a heated mass, pressure heating.

The fact that the first embossing roller 112 and the micro- or nanostructures on its surface are made from a single bulk, bears multiple advantages. One advantage is that the micro- or nanostructures may be engraved directly in the surface of the first embossing roller 112. In the prior art described herein above, the structuring of the embossing roller involves separate technologies such as a shim or a photoresist layer which imply important limitations to heights of the embossing structures. In contrast, and as will be seen along the examples described herein below, the direct engraving of the embossing structures at the surface of the first embossing roller 112 allows to create structures with a comparatively greater height than in prior art, but also to create combinations of structures, which is unknown in prior art. The use of a single bulk also further provides an advantage in thermal management of the first embossing roller 112, since heat may more easily and more homogeneously distribute in a bulk than in an embossing roller using shims or photoresist technology as in prior art.

In preferred embodiments, the first embossing roller may comprise a single metal or a metallic alloy from the following list comprising steel, copper, aluminum, lead, nickel, tin, titanium, zinc, brass and bronze.

In even further preferred embodiments, the first embossing roller comprises a ceramic material such as carbides, oxides, nitrides, carbo-nitrides of one of the following elements: B, Al, Si, Cr, Ti or any combination thereof.

Referring to FIG. 1B this represents a variant of the set-up in FIG. 1A in which a different sandwich structure is prepared and embossed, using two thermoformable layers 108, one on either side of the carrier substrate 110. The set-up is in many constituents similar to that of FIG. 1A except that the second embossing roller is replaced by a roller similar to the first embossing roller 112. This may carry micro- or nanostructures to be embossed on its cylindrical surface 114 to produce embossed structures in the corresponding thermoformable layer 108, and which are not necessarily the same as on the other embossing roller 112, as is illustrated in magnified view 118.

In a preferred embodiment, the feeding of the sandwich structure 109 in the nip 111 is done at a speed between 50 m/min and 1500 m/min.

In an even more preferred embodiment, the feeding of the sandwich structure 109 in the nip 111 is done at a speed between 100 and 500 m/min.

In preferred embodiments the embossing rollers 112 and 113 may have diameters comprised between 100 mm and 2000 mm and lengths of their bulk cylindrical parts (i.e., without counting their shafts) comprised between 100 mm and 7500 mm.

In further preferred embodiments the carrier substrate comprises a sheet form of material with a width comprised between 100 mm and 7500 mm and much larger length, contained by a reel with the corresponding reel width between 100 mm and 7500 mm.

In preferred embodiments, the thermoformable material is any one of the list comprising a thermoformable polymer and a thermoformable elastomer.

In preferred embodiments, the first embossing roller may be provided with a coating configured to prevent an adhesion of the viscous phase of the at least one thermoformable layer, and to prevent a sticking phenomenon. The coating may be a vacuum-deposited coating having a thickness of less than 10 μm, preferably less than 5 μm, and comprising diamond-like carbon (DLC) to homogeneously cover the micro or nanostructures.

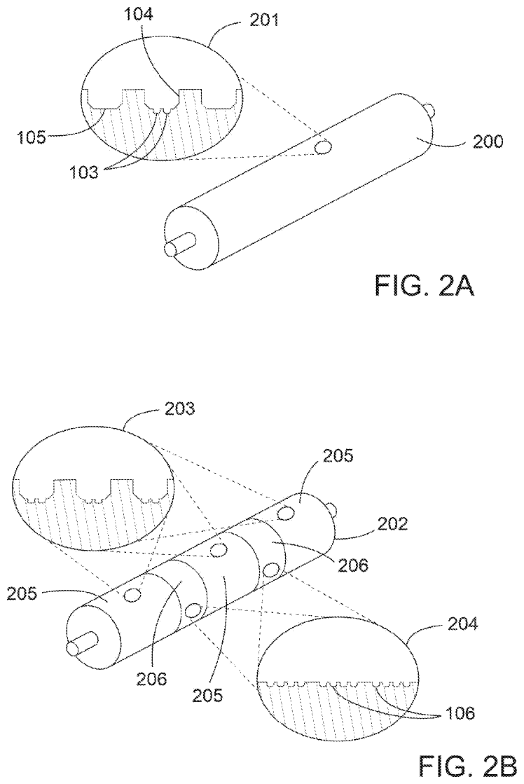

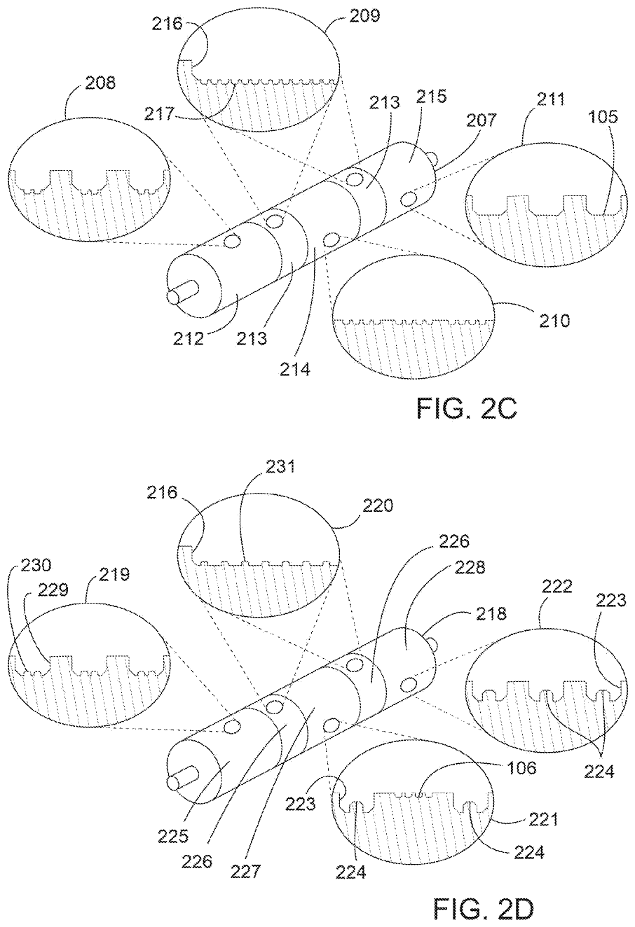

Referring to FIGS. 2A to 2D, these are schematic illustrations of embossing rollers similar to the first embossing roller 112 represented in FIG. 1, comprising embossing micro- or nanostructures according to example embodiments of the invention. The example embodiments show various configurations of micro- or nanostructures distributed in delimited zones of the embossing roller.

FIG. 2A illustrates an embossing roller 200 and a magnified view 201 of a cylindrical surface of the embossing roller 200, in which micro- or nanostructures 103-105 are shown representative for what may be found on the remaining cylindrical surface of the embossing roller 200. The micro- or nanostructures comprise at least embossing structures that are a combination of a plurality of structures, the combination comprising the first structure 104 and the second structure 103 with respectively the first width and the second width (width not explicitly marked in FIG. 2A) in a scale of at least 5 to 1, meaning that the first width is at least 5 times greater than the second width. The structures in FIG. 2A are not necessarily represented in a correct scale. Alternatively, or at the same time, the first structure 104, and the second structure 103 respectively have a first height and a second height in the scale of at least 5 to 1, meaning that the first height is at least 5 times greater than the second height. The magnified view 201 further contains representations of a simple, non-combined micro- or nanostructure 105. The examples of micro- or nanostructures illustrated in the magnified view 201 are in form of recesses only.

FIG. 2B illustrates an embossing roller 202 and magnified views 203 and 204 of a cylindrical surface of the embossing roller 202, in which magnified view 203's content is similar to that of magnified view 201 and magnified view 204 contains micro- or nanostructures 106 representative for what may be found on the remaining cylindrical surface in corresponding zones 205 and 206 respectively, of the embossing roller 202. The micro- or nanostructures 106 in magnified view 204 are simple, non-combined micro- or nanostructure. The examples of micro- or nanostructures illustrated in the magnified views 203 and 204 are in form of recesses only.

FIG. 2C illustrates an embossing roller 207 and magnified views 208-211 of a cylindrical surface of the embossing roller 207, in which magnified view 208's content is similar to that of magnified view 201, magnified view 210's content is similar to that of magnified view 204, magnified view 209 contains micro- or nanostructures 216 and 217, and magnified view 211 contains micro- or nanostructures 105, respectively representative for what may be found on the remaining cylindrical surface in corresponding zones 212-215, of the embossing roller 207. The examples of micro- or nanostructures illustrated in the magnified views 208-211 are in form of recesses only.

FIG. 2D illustrates an embossing roller 218 and magnified views 219-222 of a cylindrical surface of the embossing roller 218, in which magnified view 219's content illustrates micro- or nanostructures structures 230 in form of protuberances, impinging from a bottom of larger structures 229, magnified view 220's content illustrates micro- or nanostructures 231 in form of protuberances, impinging from a bottom of larger structure 216, magnified view 221 contains micro- or nanostructures 223 and 224 which are combined with each other, as well as micro- or nanostructures 106 which are simple structures, and magnified view 222 contains micro- or nanostructures 223 and protuberances 224 which are combined with each other, respectively representative for what may be found on the remaining cylindrical surface in corresponding zones 225-228, of the embossing roller 218. Coming back to magnified views 221 and 222, the micro- or nanostructures comprise at least embossing structures that are a combination of a plurality of structures, the combination comprising third structure 223 and fourth structure 224 with respectively a third width and a fourth width (width not explicitly marked in FIG. 2D) in a scale of at least 5 to 1, meaning that the third width is at least 5 times greater than the fourth width. The structures in FIG. 2D are not necessarily represented in the correct scale. Alternatively, or at the same time, the third structure 223, and the fourth structure 224 respectively have a third height and a fourth height in the scale of at least 5 to 1, meaning that the third height is at least 5 times greater than the fourth height. The examples of micro- or nanostructures illustrated in the magnified views 219-222 are in form of recesses and protuberances.

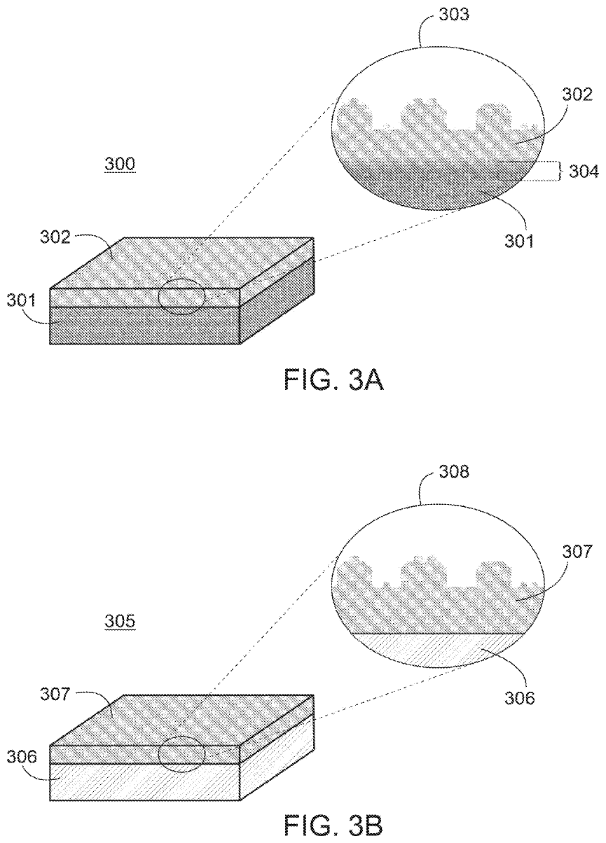

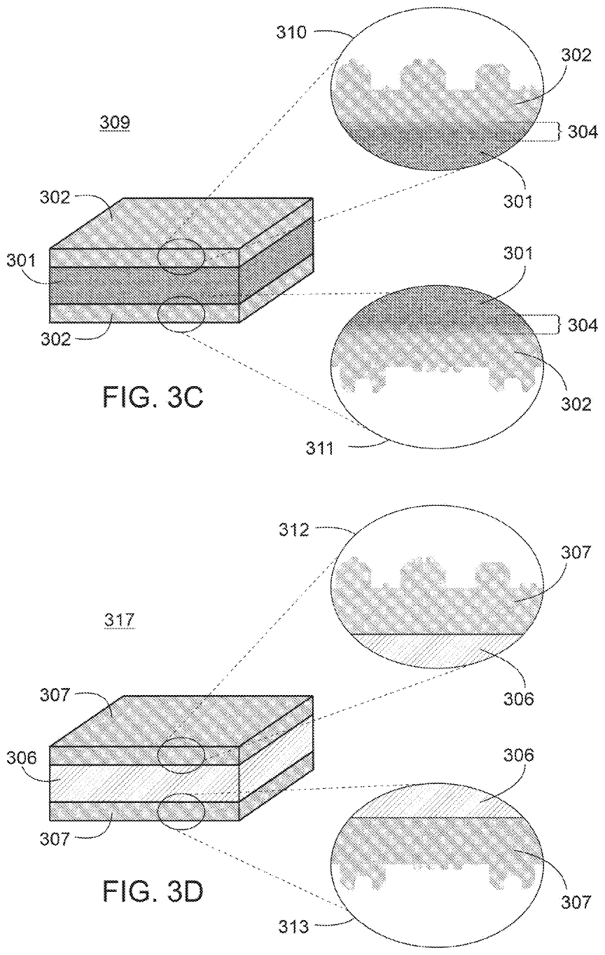

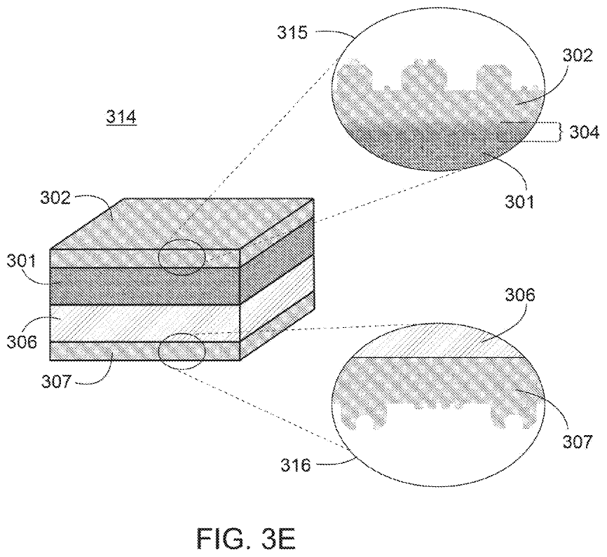

Referring now to FIGS. 3A and 3B, these show sandwich structures embossed according to example embodiments of the invention.

FIG. 3A shows a sandwich structure 300 which comprises a layer of carrier substrate 301 and a cover made of a thermoformable layer 302. The carrier substrate 301 in this example is made of a fiber-based substance. As may be seen in magnified view 303, this has the consequence that the thermoformable layer 302's material, which as mentioned before was melted to a viscous phase before being applied to the carrier substrate 301, at least in part infiltrated into interstices between the fibers of the carrier substrate 301 (interstices not visible in FIG. 3A) thereby forming a strengthened conglomerate illustrated at reference 304. Furthermore, FIG. 3A shows embossed structures of the thermoformable layer 302 in the magnified view 303.

FIG. 3B shows a sandwich structure 305 which comprises a layer of a carrier substrate 306 and a cover made of a thermoformable layer 307. The carrier substrate 306 in this example is made of a non-woven substance, e.g., a metallic or a polymer film, and is not permeable to molten material of the thermoformable layer 307. As may be seen in magnified view 308, this has the consequence that the thermoformable layer 307's material, which as mentioned before was melted to the viscous phase before being applied to the carrier substrate 306, remains at a surface of the carrier substrate 306 without infiltrating in the carrier substrate 306. Furthermore, FIG. 3B shows embossed structures of the thermoformable layer 307 in the magnified view 308.

FIG. 3C shows a sandwich structure 309 which comprises the layer of carrier substrate 301 and on both of the sides of the carrier substrate 301 one cover made of the thermoformable layer 302. The carrier substrate 301 is again made of a fiber-based substance. As may be seen in magnified view 310 with one of the thermoformable layers 302, this has the consequence that the thermoformable layer 302's material, which as mentioned before was melted to the viscous phase before being applied to the carrier substrate 301, at least in part infiltrated into interstices of the fibers of the carrier substrate 301 (interstices not visible in FIG. 3C) thereby forming a strengthened conglomerate illustrated at reference 304.

Magnified view 311 shows the other one of the thermoformable layers 302 which also forms a strengthened conglomerate illustrated at reference 304.

Furthermore, FIG. 3C shows embossed structures of the thermoformable layer 302 in the magnified views 310 and 311.

FIG. 3D shows a sandwich structure 317 which comprises the layer of carrier substrate 306 and on both of the sides of carrier substrate 306, one cover made of the thermoformable layer 307. The carrier substrate 306 in this example is made of a non-woven substance, e.g., a metallic or a polymer film, and is not permeable to molten material of the thermoformable layers 307. As may be seen in magnified views 312 and 313, this has the consequence that the thermoformable layer 307's material, which as mentioned before was melted to the viscous phase before being applied to the carrier substrate 306, remains at the surface of the carrier substrate 306 without infiltrating in the carrier substrate 306. Furthermore, FIG. 3E shows embossed structures of the thermoformable layers 307 in the magnified view 312 and 313.

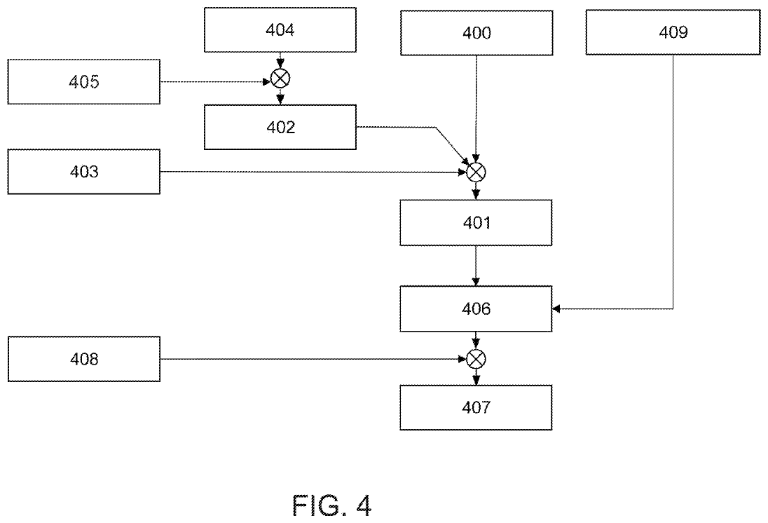

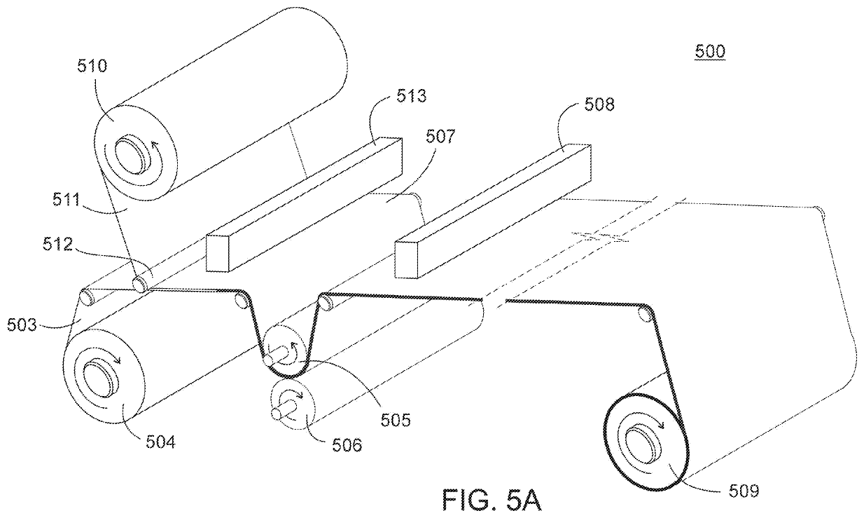

FIG. 3F shows a sandwich structure 314 which comprises 2 layers of carrier substrate respectively 301 and 306, with each a cover made of the thermoformable layer respectively 302 and 307 known from the previous examples. Magnified views 315 and 316 show respectively a case for the fiber-based substance and the non-woven substance. Referring to FIG. 4, this contains a flowchart illustrating a method for seamlessly embossing of micro- or nanostructures into a thermoformable layer of a sandwich structure according to an example embodiment of the invention. A carrier substrate 400 is used in the making of a sandwich structure 401 that comprises a layer of the carrier substrate 400 and a cover made of thermoformable layer in a viscous phase 402 by means of a mechanical apparatus 403 as appropriate. Prior to being in a viscous phase 402 a material 404 for the thermoformable layer, which may sometimes be provided as a precursor material, is melted into a viscous phase by supply of energy 405 as appropriate. The mechanical apparatus 403 is used in a step of applying the molten material 402 of the thermoformable material onto the layer of carrier substrate 400 to ensure a homogeneous distribution of the viscous layer on the carrier substrate and obtain the sandwich structure 401 prior to actual embossing 406 the micro- or nanostructures into the thermoformable layer. The latter involves feeding the sandwich structure 401 in a nip of a set of a first embossing roller and a second embossing roller, the first embossing roller comprising the embossing micro- or nanostructures, the thermoformable layer of material being oriented towards the first embossing roller and the layer of carrier substrate oriented towards the second embossing roller. A final embossed sandwich structure 407 is obtained after a step 408 of controlling a temperature of the sandwich structure at an output of the nip to a solidifying temperature of the thermoformable layer. The step of embossing 406 is configured to use the set of first embossing roller and second embossing roller 409 in which the first embossing roller and embossing micro- or nanostructures carried thereon are made from a single bulk material, the first embossing roller comprising the embossing micro- or nanostructures in form of at least a protrusion and/or at least a recess on its cylindrical surface, the second embossing roller having a smooth cylindrical surface, further whereby the micro- or nanostructures comprise at least embossing structures that are a combination of a plurality of structures, the combination comprising a first structure and a second structure, with respectively a first width and a second width in a scale of at least 5 to 1, or respectively a first height and a second height in the scale of at least 5 to 1.

In preferred embodiments, the carrier substrate material may be for example any one of items from the list comprising a metallic film, a plastic film, a textile-based film, a foil, and a substrate with a fibrous structure.

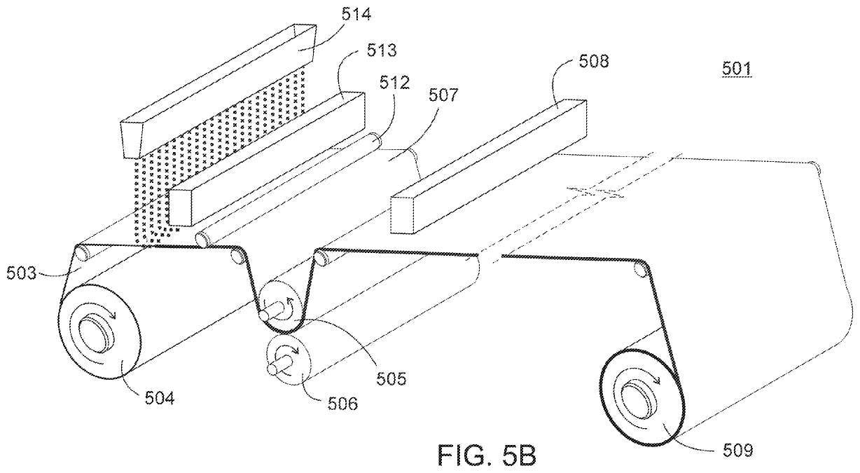

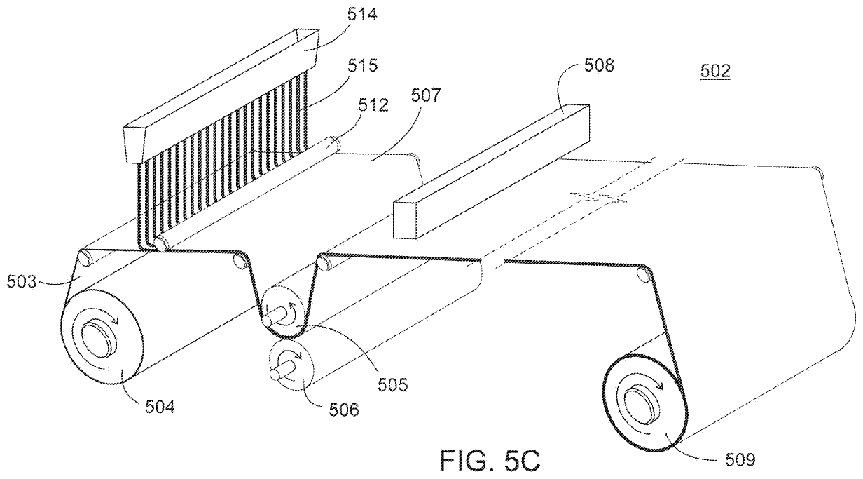

FIGS. 5A to 5C contain schematic illustrations of set-ups 500-502 configured to implement the method for seamlessly embossing micro- or nanostructures into a thermoformable layer of a sandwich structure according to example embodiments of the invention, wherein the applying of molten material of the thermoformable layer is realized in different manners.

The set-ups 500-502 have a number of features in common as follows:
a carrier substrate 503 is provided from a supply reel 504;
a set of a first embossing roller 505 that carries the embossing micro- or nanostructures (not illustrated) on its cylindrical surface, and cooperates with a second embossing roller 506 with a smooth cylindrical surface to emboss a sandwich structure 507;
a temperature controlling device 508 configured to control a temperature of the sandwich structure at an output of the nip of the set of embossing rollers, to a solidifying temperature of the thermoformable layer; and
a collecting reel 509 configured to collect the embossed sandwich structure 507 for further later use.

As already hinted, the set-ups 500-502 differ by the manner in which the applying of molten material of the thermoformable layer is realized.

In the set-up 500, the thermoformable layer 511 is supplied from a thermoformable sheet reel 510 and brought into contact with the carrier substrate 503. The contacting may be improved by an application roll 512. The thermoformable layer is subsequently melted by an energy-delivering device 513 to adhere on the carrier substrate 503, in form of a viscous layer of material, before being conveyed to the embossing rollers 505 and 506.

In the set-up 501, the thermoformable layer material is supplied from a container 514 in form of powder and deposited on the carrier substrate 503 before being conveyed to be melted by the energy-delivering device 513 to adhere on the carrier substrate 503. The adhering may be improved by means of the application roll 512.

In the set-up 502, the thermoformable layer material is supplied from the container 514 in form of viscous filaments or a viscous continuous curtain and deposited on the carrier substrate 503 before being conveyed to be melted by the energy-delivering device 513 to adhere on the carrier substrate 503. The adhering may be improved by means of the application roll 512.

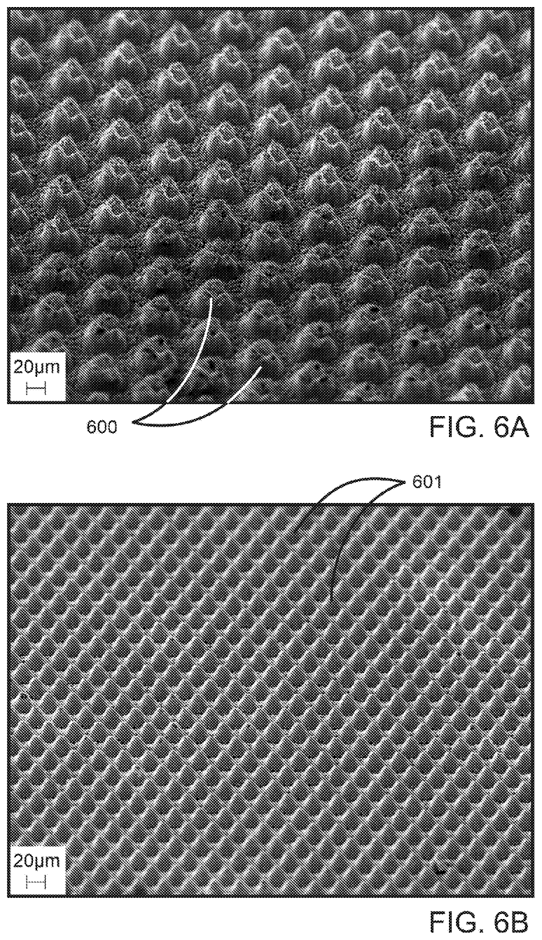

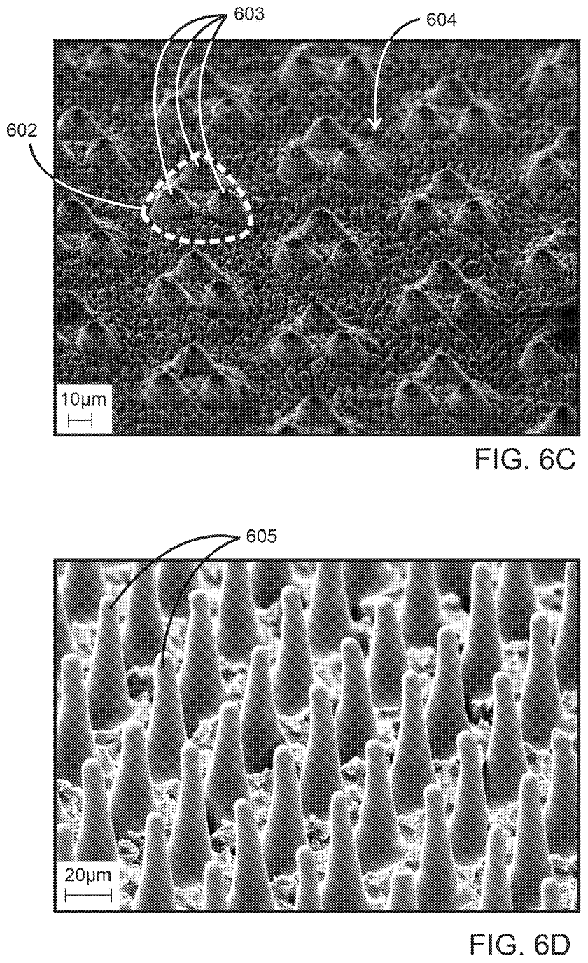

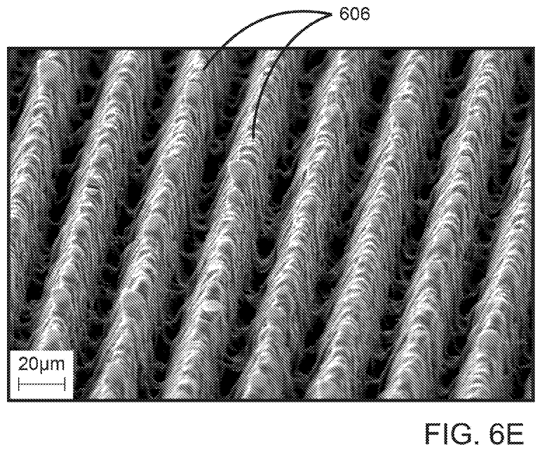

Referring to FIGS. 6A to 6E, these each contain a scanning electron microscope photograph of a surface of an embossed thermoformable layer carrying micro- or nanostructures embossed according to example embodiments of the invention.

FIG. 6A shows embossing structures 600 that each are a combination of a plurality of smaller structures, and all have been positioned on the surface of the thermoformable layer in a regular grid. The smaller structures are not visible in isolation, only in their combination structure 600.

The height of the combined structures is about 30 μm.

FIG. 6B shows embossing structures 601 which in this case are each a single cone-shaped structure. The structures 601 are positioned in a regular grid.

The height of the structures is about 15 μm.

FIG. 6C shows embossing structures 603 grouped by 3 respectively in a group 602. The latter are positioned on the surface of the thermoformable layer in a regular grid. The very small roughness features 604 are attributable to a roughness on the non-embossed thermoformable layer, and are not created by embossing.

The height of the structures is about 10 μm.

FIG. 6D shows embossing structures 605 which in this case are each a single cone-shaped structure. The structures 605 are positioned in a regular grid.

The height of the structures is about 40 μm.

FIG. 6E shows embossing structures 606 which constitute parallel ridges on the thermoformable layer, according to an example embodiment of the invention.

The height of the ridges is about 30 μm and their width is about 20 μm.

Various structures shown in FIGS. 6A-6E may be combined among each other as appropriate.

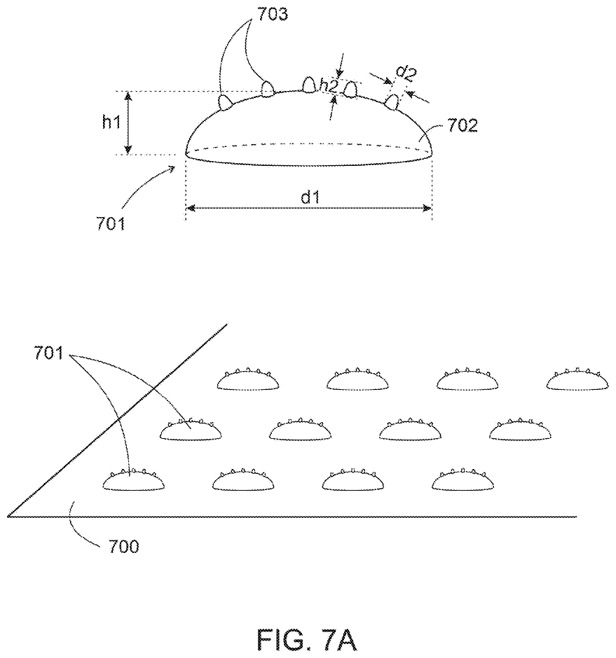

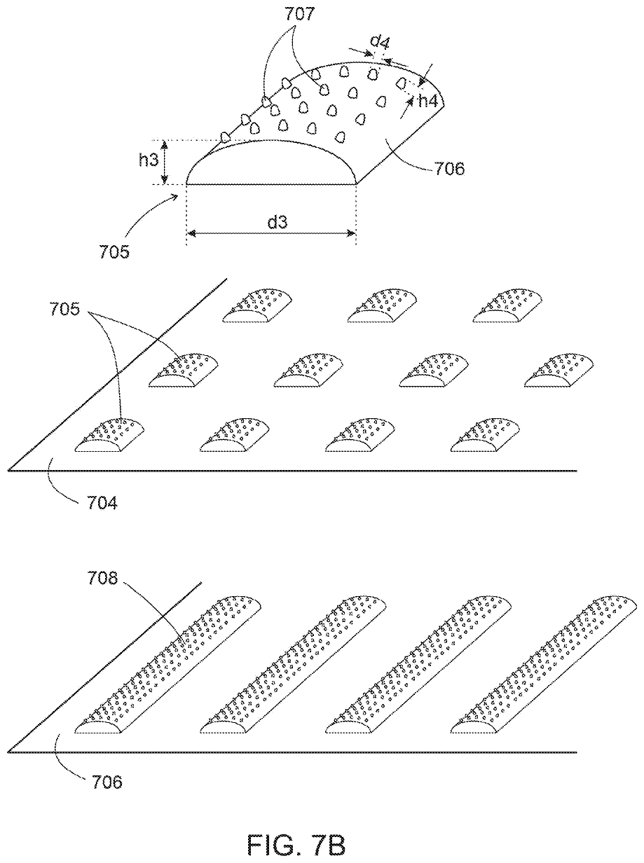

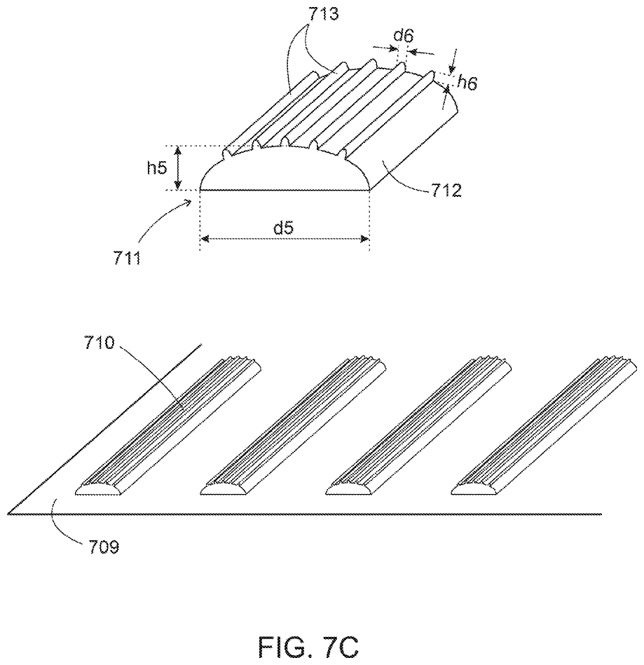

Referring to FIGS. 7A to 7C, these illustrate examples of a thermoformable layer embossed with combined structures and conglomerates of these combined structures. The structures illustrated are not necessarily represented in the right scale for reasons of readability.

FIG. 7A shows a thermoformable layer 700 embossed with combined structures 701 positioned according to a regular grid. FIG. 7A further shows a magnified version of the combined structure 701 which comprises a dome-shaped structure 702 having a width d1 and a height h1. Also represented as part of the combined structure 701 are a plurality of smaller cone-shaped structures 703 distributed on a surface of the dome-shaped structure 702, each having a width d2 and a height h2. According to the invention the scale between widths on one hand and heights on the others is as follows:

$$\\ ( h 1 / h 2 ) > 5 and ( d 1 / d 2 ) > 5$$

In preferred embodiments d1 may vary between 5 am and 100 μm, more preferably between 10 μm and 50 μm, whereas h1 may be smaller than 100 μm, more preferably may vary between 5 μm and 30 μm.

FIG. 7B shows a thermoformable layer 704 embossed with combined structures 705 positioned according to a regular grid. FIG. 7B further shows a magnified version of the combined structure 705 which comprises a round-shaped longitudinal structure 706 having a width d3 and a height h3. Also represented as part of the combined structure 705 are a plurality of smaller cone-shaped structures 706 distributed on a surface of the round-shaped longitudinal structure 706, each having a width d4 and a height h4. According to the invention the scale between widths on one hand and heights on the others is as follows:

$$\\ ( h 3 / h 4 ) > 5 and ( d 3 / d 4 ) > 5.$$

In preferred embodiments d3 may vary between 5 μm and 100 μm, more preferably between 10 μm and 50 μm, whereas h3 may be smaller than 100 μm, more preferably may vary between 5 am and 30 μm.

FIG. 7B further shows conglomerates of the combined structures 705 which form a series of parallel ridges 708.

FIG. 7C shows a thermoformable layer 709 embossed with conglomerates 710 of combined structures 711. The combined structure 711 is also illustrated in isolation for reasons of better understandability. The combined structure 711 comprises a round-shaped longitudinal structure 712 having a width d5 and a height h5. Also represented as part of the combined structure 711 are a plurality of smaller ridge structures 713 with a cone-shaped cross-section, distributed on a surface of the round-shaped longitudinal structure 712, each having a width d6 and a height h6. According to the invention the scale between widths on one hand and heights on the others is as follows:

$$\\ ( h 5 / h 6 ) > 5 and ( d 5 / d 6 ) > 5.$$

In preferred embodiments, d5 may vary between 5 μm and 100 μm, more preferably between 10 μm and 50 μm, whereas h5 may be smaller than 100 μm, more preferably may vary between 5 μm and 30 μm.

In the present example the conglomerates 710 form a series of parallel ridges. According to the invention, a total height of structures and/or combined structures is merely limited by a thickness of the thermoformable layer. This enable to make structures and/or combined structures much greater in height than in prior art as described in the present description, because in prior art the height of structures is strictly limited by the technology for structuring the embossing roller's surface, which is photoresist layer technology. The latter is limited to a maximum of 2 μm, whereas the invention may go way beyond this limit.

See for example FIG. 6D where the structures 605 have a height of around 40 μm.

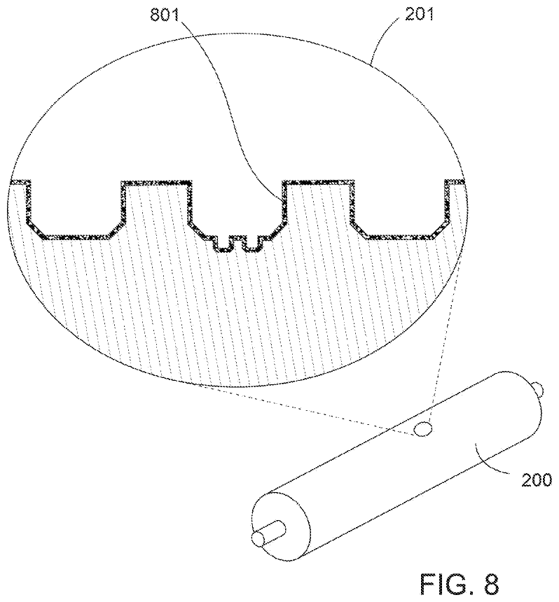

FIG. 8 shows a preferred embodiment of the embossing roller 200 according to the invention, in which the roller 200 is coated with a thin, i.e., with a thickness below 10 μm, vacuum-deposited coating 801 having anti-adhesion properties. The magnified view 201 shows the coating 801 homogeneously recovering the micro- and nanostructures.

In a preferred embodiment, the coating 801 may consist of a PECVD-deposited diamond-like carbon (DLC) layer with a thickness smaller than 5 μm.

Thickness of thermoformable layer There is a minimum value for the thickness of the thermoformable layer, given by the peak-to-valley height between the highest protrusion and the lowest recess of the embossing micro- and nanostructures of the first embossing roller and a maximum value that is rather given by economical or technological considerations, namely at around 50 μm.

The temperature of the thermoformable layer is imposed by the glass transition temperature of the specific material 404 and it may be situated at roughly
80° C. for PET (Polyethylene Terephthalate);
85° C. for PVC (Polyvinyl Chloride);
100° C. for PS (Polystyrene); and
145° C. for PC (Polycarbonate).

1. Method for seamlessly embossing micro- or nanostructures into at least one thermoformable layer of a sandwich structure,
the sandwich structure comprising a layer of carrier substrate and a cover made of the at least one thermoformable layer,
whereby the micro- or nanostructures comprise at least embossing structures that are a combination of a plurality of structures, the combination comprising a first structure and a second structure, with respectively a first width and a second width in a scale of at least 5 to 1, or respectively a first height and a second height in the scale of at least 5 to 1,
the method comprising
melting material of the at least one thermoformable layer to a viscous phase;
applying the molten material of the at least one thermoformable layer onto the layer of carrier substrate to obtain the sandwich structure prior to embossing;
the method further comprising
maintaining the material of the at least one thermoformable layer in the viscous phase prior to embossing;
feeding the sandwich structure in a nip of a set of a first embossing roller and a second embossing roller, the first embossing roller and the embossing micro- or nanostructures carried thereon being made from a single bulk material, the first embossing roller comprising the embossing micro- or nanostructures in form of at least a protrusion and/or at least a recess on its cylindrical surface, the second embossing roller having a smooth cylindrical surface, the at least one thermoformable layer of material being oriented towards the first embossing roller and the layer of carrier substrate oriented towards the second embossing roller;
embossing the micro- or nanostructures into the at least one thermoformable layer; and
controlling a temperature of the sandwich structure at an output of the nip to a solidifying temperature of the at least one thermoformable layer.

2. The method of claim 1, wherein the feeding of the sandwich structure in the nip is done at a speed between 50 m/min and 1500 m/min.

3. The method of claim 2, wherein the feeding of the sandwich structure in the nip is done at a speed between 100 and 500 m/min.

4. The method of claim 1, wherein
the carrier substrate is made of a fiber-based substance; and
the step of applying of the molten material of the at least one thermoformable layer onto the layer of carrier substrate causes at least part of the molten material of the at least one thermoformable layer to infiltrate into interstices between the fibers the carrier substrate, thereby forming a strengthened conglomerate.

5. The method of claim 1, wherein
the applying of the molten material of the at least one thermoformable layer onto the layer of carrier substrate comprises an injection under pressure of the molten material.

6. The method of claim 1, wherein
the step of maintaining the material of the at least one thermoformable layer in a viscous phase comprises a thermal management of the material of the thermoformable layer by any one of the means from the list comprising an oven, an infrared source of heat, an electromagnetic radiation source, a heated mass, pressure heating.

7. The method of claim 1, wherein
the first embossing roller comprises a single metal or a metallic alloy from the following list comprising steel, copper, aluminum, lead, nickel, tin, titanium, zinc, brass and bronze.

8. The method of claim 1, wherein
the first embossing roller comprises a ceramic material such as carbides, oxides, nitrides, carbo-nitrides of one of the following elements: B, Al, Si, Cr, Ti or any combination thereof.

9. The method of claim 1, further wherein the micro- or nanostructures further comprise any one of grooves and ridges.

10. The method of claim 1, further wherein
the thermoformable material is any one of the list comprising a thermoformable polymer and a thermoformable elastomer.

11. The method of claim 1, further comprising
providing the embossing roller with a coating configured to prevent an adhesion of the viscous phase of the at least one thermoformable layer, and to prevent a sticking phenomenon.

12. The method of claim 11, wherein
the coating is a vacuum-deposited coating having a thickness of less than 10 μm, preferably less than 5 μm, and comprising diamond-like carbon (DLC) to homogeneously cover the micro or nanostructures.

13. The method of claim 1, further wherein
the carrier substrate material is any one of items from the list comprising a metallic film, a plastic film, a textile-based film, a foil, and a substrate with a fibrous structure.

14. The method of claim 1, further comprising
providing a second thermoformable layer on a side of the carrier substrate opposite to the side on which the at least one thermoformable layer is formed,
maintaining a second material of the second thermoformable layer in a viscous phase prior to embossing;
providing the second embossing roller with further micro- or nanostructures for embossing these in the second thermoformable layer;
controlling a second temperature of the sandwich structure at an output of the nip to a solidifying temperature of the second thermoformable layer.

15. System for seamlessly embossing micro- or nanostructures into at least one thermoformable layer of a sandwich structure, wherein
the sandwich structure comprises a layer of carrier substrate and a cover made of the at least one thermoformable layer,
whereby the micro- or nanostructures comprise at least embossing structures that are a combination of a plurality of structures, the combination comprising a first structure and a second structure, with respectively a first width and a second width in a scale of at least 5 to 1, or respectively a first height and a second height in the scale of at least 5 to 1,
the system comprising
a melting system configured for melting material of the at least one thermoformable layer to a viscous phase;
an application system configured for applying the molten material of the at least one thermoformable layer onto the layer of carrier substrate to obtain the sandwich structure prior to embossing;
the system further comprising
a first thermal management system configured for maintaining the material of the at least one thermoformable layer in the viscous phase prior to embossing;
a conveyer system configured for feeding the sandwich structure in a nip of a set of a first embossing roller and a second embossing roller configured to emboss the micro- or nanostructures into the at least one thermoformable layer, wherein
the first embossing roller and embossing micro or nanostructures carried thereon are made from a single bulk material,
the first embossing roller comprises the embossing micro- or nanostructures in form of at least a protrusion and/or at least a recess on its cylindrical surface,
the second embossing roller has a smooth cylindrical surface, and
the at least one thermoformable layer of material is oriented towards the first embossing roller and the layer of carrier substrate oriented towards the second embossing roller; and
a second thermal management system configured for controlling a temperature of the sandwich structure at an output of the nip to a solidifying temperature of the at least one thermoformable layer.

16. The system of claim 15, wherein
the sandwich structure further comprises a second thermoformable layer on a side of the carrier substrate opposite to the side on which the at least one thermoformable layer is formed,
the first thermal management system is further configured to maintain a second material of the second thermoformable layer in the viscous phase prior to embossing;
the second embossing roller is configured to comprise further micro- or nanostructures for embossing these in the second thermoformable layer;
the second thermal management system is further configured for controlling a second temperature of the sandwich structure at an output of the nip to a solidifying temperature of the second thermoformable layer.
